(19) United States
(12) Patent Application Publication
(10) Pub. No.: US 2017/0186073 A1
(43) Pub. Date: Jun. 29, 2017

(54) SHOPPING CART DISPLAY

(71) Applicant: Wal-Mart Stores, Inc., Bentonville, AR (US)

(72) Inventors: Greg Bryan, Bentonville, AR (US); John Paul Thompson, Bentonville, AR (US); Eric Anthony Letson, Bentonville, AR (US)

(21) Appl. No.: 15/383,227

(22) Filed: Dec. 19, 2016

Related U.S. Application Data
(60) Provisional application No. 62/387,542, filed on Dec. 24, 2015.

(51) Int. Cl. G06Q 30/06; G06F 3/14

(52) U.S. Cl. CPC G06Q 30/0633; G06F 3/14; G06Q 30/0643

(57) ABSTRACT

A shopping cart communication system comprises a shopping cart including a head up display, the head up display operable by a mobile electronic device and a retailer application executed on the mobile electronic device that communicates with the head up display, and generates display data for output to and display at the head up display.

### RELATED APPLICATIONS

This application claims priority to U.S. Provisional Patent Application No. 62/387,542, filed Dec. 24, 2015 and entitled “Shopping Cart Display,” the entirety of which is incorporated by reference herein.

### FIELD

The present inventive concepts relate generally to shopping cart displays, and more specifically, to a head-up display (HUD) operating in a shopping environment.

### BACKGROUND

Store customers often use their personal mobile devices such as smartphones while shopping.

### BRIEF SUMMARY

In one aspect, provided is a shopping cart communication system, comprising: a shopping cart including a head up display, the head up display operable by a mobile electronic device; and a retailer application executed on the mobile electronic device that communicates with the head up display, and generates display data for output to and display at the head up display.

In some embodiments, the head up display includes an extension to the mobile electronic device for operating only in response to the display data received from the mobile electronic device.

In some embodiments, the head up display includes a touchscreen.

In some embodiments, the head up display is removably attached to a handle or basket portion of the shopping cart in a field of vision of a shopper behind the shopping cart handle, a first region of the head up display provides a transparent or semi-transparent line of sight for the shopper, and a second region of the head up display provides a display of the display data.

In some embodiments, the head up display displays images via an embedded pico projector or via a semi-transparent liquid crystal display (LCD) technology.

In some embodiments, a user of the shopping cart users the mobile electronic device to display content on the head up display via an ecommerce application installed and executed on the mobile electronic device.

In some embodiments, the head up display is not an intelligent device and requires the mobile electronic device to function.

In some embodiments, the mobile electronic device communicates with the head up display via Bluetooth™, WiFi, or USB-based connection.

In some embodiments, the system further comprises a docking station on the shopping cart for holding the mobile electronic device in communication with the head up display.

In some embodiments, the head up display is removably coupled to a handle or basket of the shopping cart.

In some embodiments, the shopping cart communication system further comprises a server that communicates with the retail application on the mobile electronic device to provide data to the mobile electronic device, wherein the display data is generated in response to the data received by the mobile electronic device from the server.

In some embodiments, the shopping cart communication system further comprises a charging system that produces power from motion of the shopping cart wheels, and provides the power to the head up display.

In another aspect, provided is a shopping cart, comprising a frame; a handle; a set of wheels coupled to the frame; a basket; and a head up display removably or permanently coupled to the handle, basket, or frame, the head up display operable only by a mobile electronic device, wherein the head up display displays data received by the mobile electronic device.

In some embodiments, the head up display includes an extension to the mobile electronic device for operating only in response to the display data received from the mobile electronic device.

In some embodiments, the head up display is in a field of vision of a shopper behind the shopping cart handle, wherein a first region of the head up display provides a transparent or semi-transparent line of sight for the shopper, and wherein a second region of the head up display provides a display of the display data.

In another aspect, provided is method, comprising: coupling a head up display to a shopping cart; executing an application at a mobile electronic device; providing a result of the executed application to the head up display; and activating the head up display in response to the received result, and projecting an image from the data at a first region of the display.

In some embodiments, a user has a line of sight through a second region of the head up display.

### BRIEF DESCRIPTION OF THE SEVERAL VIEWS OF THE DRAWINGS

The above and further advantages may be better understood by referring to the following description in conjunction with the accompanying drawings, in which like numerals indicate like structural elements and features in various figures. The drawings are not necessarily to scale, emphasis instead being placed upon illustrating the principles of the concepts.

FIG. 1 is a perspective view of a shopping cart, in accordance with some embodiments.

FIG. 2 is a view of a mobile electronic device communicating with a HUD apparatus, in accordance with some embodiments.

FIG. 3 is a diagram of a method for display at a shopping cart, in accordance with some embodiments.

FIG. 4 is a flow diagram illustrating an operation involving a shopping cart display, in accordance with some embodiments.

### DETAILED DESCRIPTION

It is difficult for store customers to use their smartphones while pushing a shopping cart. Accordingly, embodiments of the present inventive concepts can improve a store customer's shopping experience by configuring a head up display (HUD) on a shopping cart to communicate with the customer's personal mobile device such as a smartphone, tablet, notebook, laptop computer, and so on, and for providing an additional display for content generated at mobile device. The HUD relies on the processing power of the shopper's mobile electronic device, which executes a shopping application, and outputs the result to the HUD for display. The HUD cannot operate on its own, and requires the mobile electronic device in order to serve as an extension of a retailer application executed at the mobile electronic device or other in-store generated application.

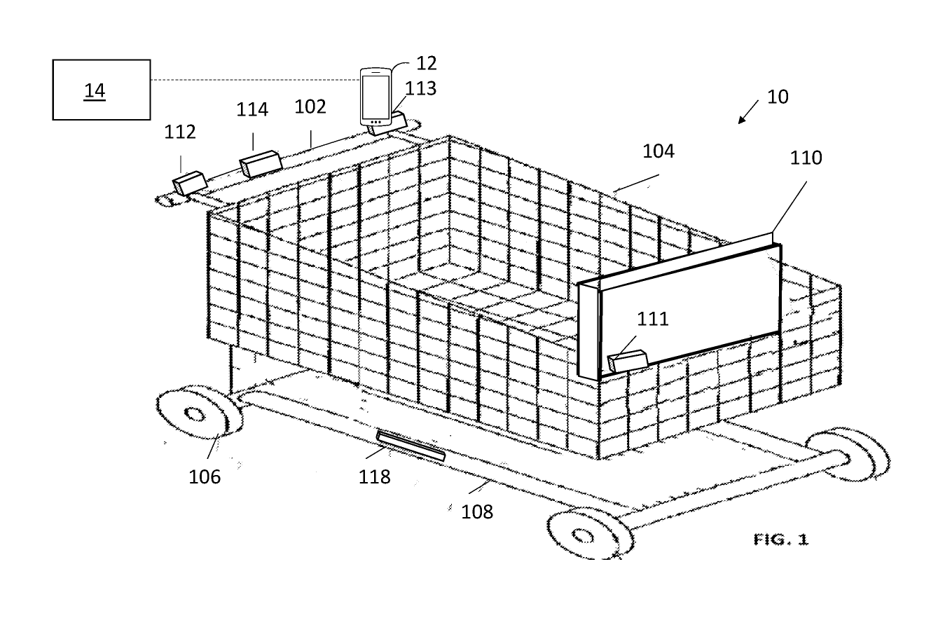

FIG. 1 is a perspective view of a shopping cart 10, in accordance with some embodiments. The shopping cart 10 may include well-known components such as a handle 102, basket 104 attached to a base 108, wheels also attached to the base 108, and so on.

A HUD apparatus 110 may be attached to the shopping cart 10. In some embodiments, the HUD apparatus 110 is removably coupled to the shopping cart 10. In other embodiments, the HUD apparatus 110 is mounted or otherwise permanently affixed to the shopping cart 10. The HUD apparatus 110 can be positioned at a rear region of the basket 104. Alternatively, the HUD apparatus 110 can be positioned at a front region of the basket 104, or coupled to the handle 102, or positioned anywhere on the shopping cart 10 such that the viewable area of the display is in a field of vision of a user of the shopping cart 10. The HUD apparatus 110 can be coupled to a hinged device or other mechanical components so that the HUD apparatus 110 can be moved relative to a position on the shopping cart 10, for example, swivel about an axis along which a rod extends from the cart 10. The HUD apparatus 110 can be constructed and arranged for a small footprint, for example, folded behind a child seat (not shown) on the shopping cart 10.

In some embodiments, the HUD apparatus 110 is a semitransparent display, or partially transparent or see-through display, so that the screen can display data that is projected onto it while allowing a viewer to see through the screen and obtain a view of the other side of the screen (similar to an automobile windshield). In some embodiments, the HUD apparatus 110 is part of a transparent flexible liquid crystal display (LCD) or laser projection unit, for example, integrated laser-based pico projector or related handheld projector, which projects an image provided by a mobile electronic device. In some embodiments, the HUD apparatus 110 includes a touchscreen. For example, a user can press an icon or graphical representation on the HUD scree, which triggers a communication with the mobile electronic device.

A HUD interface 111 provides for communication to be established between the HUD apparatus 110 and a mobile electronic device, which outputs data for display on the HUD apparatus 110. The HUD interface 111 permits the HUD apparatus 110 to receive data from the mobile electronic device via cable or wireless communication such as Bluetooth™ or the like. Display data is first generated at the mobile electronic device, for example, by an application executed at the mobile electronic device, then output to the HUD apparatus 110. The same data may be displayed on a display screen on the mobile electronic device. In some embodiments, a USB interface or the like can be coupled to the shopping cart 10 for providing data from an electronic device, for example, a mobile electronic device, laptop computer, notebook, and so on.

The shopping cart 10 may include a camera 112, a scanning device 114 (e.g., barcode, QR, and so on), and/or other electronic devices such as sensors or the like that may receive an input and provide the input to the mobile electronic device where it may be processed, then displayed at the HUD apparatus 110. For example, the camera 112 may provide data of an image of interest to the mobile electronic device, which processes the image data, and outputs the image data to the HUD apparatus 110 for display. In some embodiments, the camera, scanning device, and/or other sensors can be part of the mobile electronic device, which provides data input via the camera, sensor, and so on to the shopping cart 10 via the HUD interface 110. The shopping cart 10 may include but not be limited to other devices for gathering data used by the shopper's smartphone or other electronic device for generating an output for display at the HUD apparatus 110, for example, a beacon reader, near field communication (NFC) reader, barcode scanner, and so on.

In some embodiments, the shopping cart 10 can include a docking station 113, or dock holder, for holding the mobile electronic device in communication with the HUD apparatus 110. The HUD apparatus 110 can receive power from a battery 118, for example, located at the base 108 as shown, or at the handle 102, or elsewhere on the shopping cart 10. Alternatively or additionally, power may be generated by a charging system, for example, a voltage generator which produces power from motion of the shopping cart wheels 106. The charging system may charge the battery 118, which in turn powers the HUD apparatus 110, or provide power directly to the HUD apparatus 110.

In accordance with some embodiments, the shopping cart 10 and mobile electronic device 12, or more specifically, retail applications, e-commerce applications, or other applications part of a shopping experience executed at the device 12 are part of a shopping cart communication system. One or more computer servers 14 may be part of the system, for providing data to the mobile electronic device 12 and/or the HUD apparatus 110. For example, the mobile electronic device may request and receive location data via GPS or the like, which can be displayed at the HUD apparatus 110. A feature is that the HUD apparatus 110 relies on the mobile electronic device 12 for processing functions, and displays a result of the processing functions performed at the mobile electronic device 12.

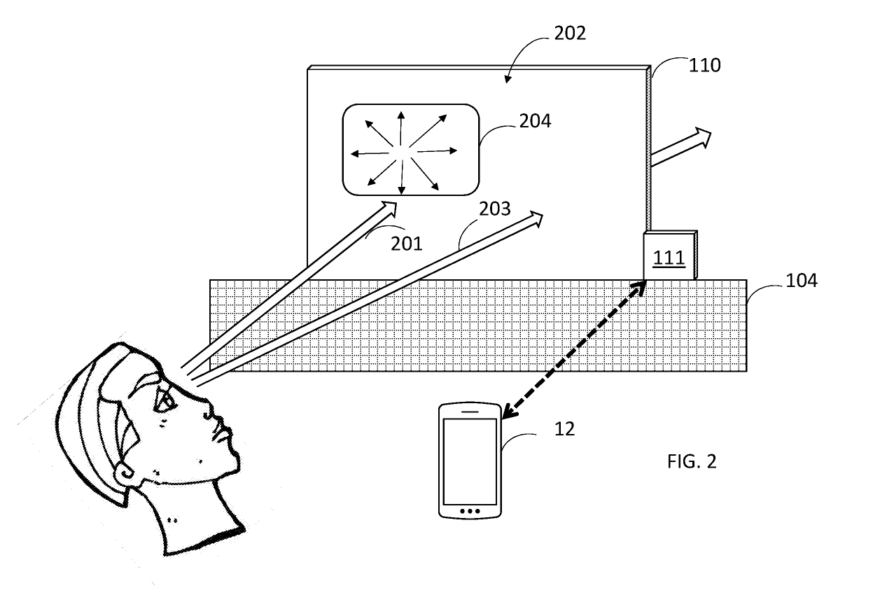

FIG. 2 is a view of a mobile electronic device 12 communicating with a shopping cart HUD apparatus 110, in accordance with some embodiments.

As shown, the HUD apparatus 110 includes a display screen 202 that displays data projected onto a region 204 of the display. A viewer can view 201 images generated from data executed at the mobile device 12. The viewer can also see through another region of the display screen 202 for viewing 203 objects, scenery, etc. on the other side of the HUD apparatus 110, similar to a glass window. In other words, operations performed on the mobile electronic device 12 are reflected on the display of the HUD apparatus 110. Accordingly, a store customer can view data displayed on the HUD apparatus 110 without diverting attention from the view through the transparent region of the HUD apparatus 110.

The mobile electronic device 12 may communicate with the HUD apparatus, or more specifically, interface 111, via Bluetooth™ or related communication protocol. More specifically, the mobile electronic device 12 stores and executes a retailer application that when executed establishes an electronic communication with the HUD apparatus 110.

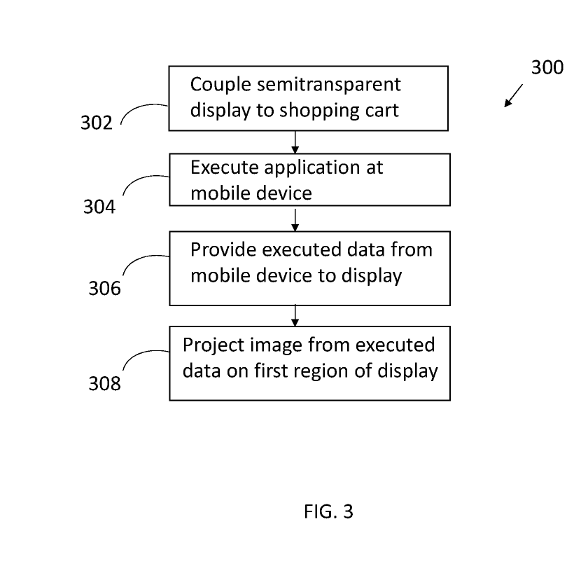

FIG. 3 is a method 300 for display at a shopping cart, in accordance with some embodiments. Some or all of the method 300 can be performed at a shopping cart 10 and/or mobile electronic device 12 illustrated at FIGS. 1 and 2.

At block 302, a semitransparent display, for example, a HUD, pico projector, and so on, is coupled to a shopping cart. The display can be positioned on the shopping cart so that a user of the shopping cart can see through the display, or have a line of sight, similar to an automobile windshield, when moving the shopping cart, for example, positioning the display at a front of the basket of the shopping cart, or along the handle of the shopping cart. In other embodiments, the display is not along a line of sight of the shopping cart user positioned at and holding the handle of the shopping cart, but is instead positioned along a side of the shopping cart basket, below the handle, or positioned at another region of the shopping cart.

At block 304, an application is executed at a mobile electronic device. The application may relate to a shopping application. Examples may include but not be limited to a shopping list, in store navigation guides and waypoints, product information, nutritional information, item reviews, recipe suggestions, advertisements and promotions, analytic data, for example, shopping patterns, tracking information, e-commerce, point of sale or payment, and so on. The mobile device 12 and/or shopping cart 10 may include sensors or other input/output devices for receiving signals that may be used by the application for executing the application. For example, a camera on the mobile electronic device 12 may capture an image of an item, which is processed by an application executed at the mobile device 12. In another example, information regarding a store item may be received by scanning a QR code, whereby a shopping application on the phone processes the received data on the QR code to obtain information about the item stored at a database.

In other example, devices on the shopping cart 10 may establish a current location of the shopping cart 10 in the store. The customer's mobile device can execute traffic system software, whereby a traffic system result is displayed at the HUD apparatus 110 for informing a customer of the locations of other shoppers in the store, for example, a large group of shoppers congregated at the meat counter. This may be achieved by each shopper's cart and/or mobile device sending location information such as speed and location information to a central tracking system (not shown).

At block 306, the executed data is provided from the mobile electronic device to the semitransparent display for display. Referring to the previous example, the image of the item executed by the mobile device application may be output to the HUD 110 for display. At block 308, the image is projected on a region of the semitransparent display.

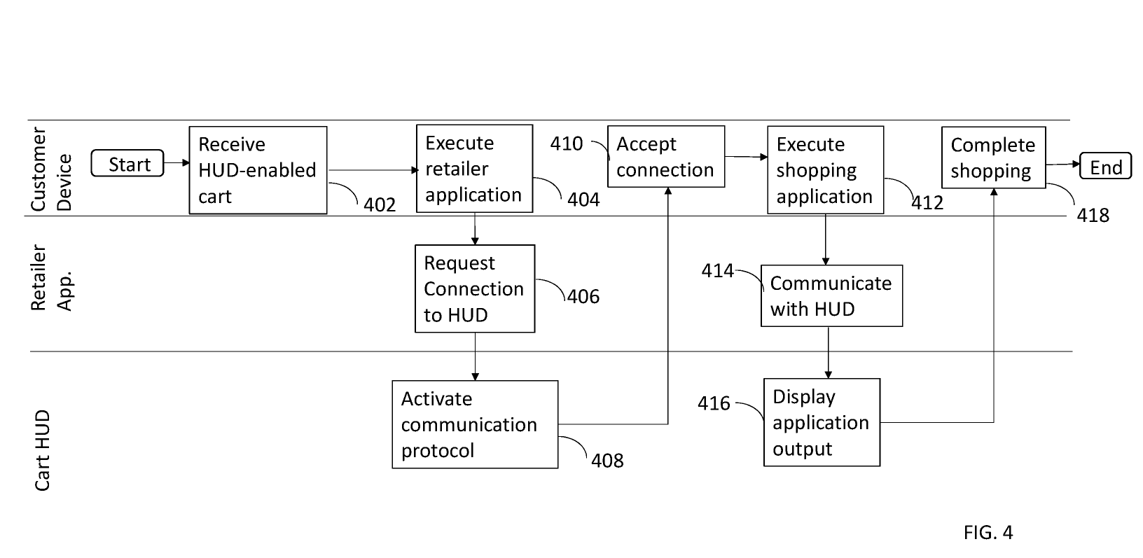

FIG. 4 is a flow diagram illustrating an operation involving a shopping cart display, in accordance with some embodiments. In describing the operation, reference is made to elements of FIGS. 1 and 2.

At block 402, a customer enters a store, and receives a shopping cart and HUD-enabled shopping cart.

At block 404, the customer executes a retailer application on the customer's smartphone or related mobile electronic device. The retailer application is configured to communicate with the HUD. The retailer application when executed may perform one or more shopping-related functions, such as but not limited to a shopping list generator, point of sale application, navigation application, marketing/ promotions, and other well-known e-commerce applications. Accordingly, at block 406, the application generates a request to establish an electronic communication with the shopping cart HUD in order to provide data to the HUD. At block 408, a communication protocol, such as Bluetooth™ or the like, is activated on the shopping cart for the HUD. At block 410, the customer can receive a message on the mobile electronic device requesting that the customer accept or reject an electronic connection, for example, a Bluetooth™ pairing, between the mobile electronic device and the shopping cart HUD.

At block 412, the customer can execute a shopping application at the mobile electronic device, such as a shopping list generator.

At block 414, the e-commerce application communicates with the shopping cart HUD.

At block 416, an output of the data generated by the shopping application is displayed at the shopping cart HUD. For example, shopping list items, navigation details, maps, promotions, and so on may be generated at the customer's smartphone and displayed at the HUD. Other functions may be performed, such as generating analytics related to shopping patterns of the customer by tracking the customer's shopping list as the customer searches for items on the list in the store. Analytic result data may also be displayed at the HUD apparatus.

For example, an e-commerce application executed on the shopper's smartphone may include an analytic processor, or communicate with a separate analytic system, to determine items that the customer is looking for, either by an item listed on the shopping list or by the customer requesting for a map to the item. Data collected may be used to form a layout of the store configured for the customer, for example, including navigation details providing an expedient path from the shopper's current location to the items of interest.

While concepts have been shown and described with reference to specific preferred embodiments, it should be understood by those skilled in the art that various changes in form and detail may be made therein without departing from the spirit and scope as defined by the following claims.

What is claimed is:

1. A shopping cart communication system, comprising:
a shopping cart including a head up display, the head up display operable by a mobile electronic device; and
a retailer application executed on the mobile electronic device that communicates with the head up display, and generates display data for output to and display at the head up display.

2. The shopping cart communication system of claim 1, wherein the head up display includes an extension to the mobile electronic device for operating only in response to the display data received from the mobile electronic device.

3. The shopping cart communication system of claim 1, wherein the head up display includes a touchscreen.

4. The shopping cart communication system of claim 1, wherein the head up display is removably attached to a handle or basket portion of the shopping cart in a field of vision of a shopper behind the shopping cart handle, wherein a first region of the head up display provides a transparent or semi-transparent line of sight for the shopper, and wherein a second region of the head up display provides a display of the display data.

5. The shopping cart communication system of claim 1, wherein the head up display displays images via an embedded pico projector or via a semi-transparent liquid crystal display (LCD) technology.

6. The shopping cart communication system of claim 1, wherein a user of the shopping cart users the mobile electronic device to display content on the head up display via an ecommerce application installed and executed on the mobile electronic device.

7. The shopping cart communication system of claim 1, wherein the head up display is not an intelligent device and requires the mobile electronic device to function.

8. The shopping cart communication system of claim 1, wherein the mobile electronic device communicates with the head up display via Bluetooth™, WiFi, or USB-based connection.

9. The shopping cart communication system of claim 1, further comprising a docking station on the shopping cart for holding the mobile electronic device in communication with the head up display.

10. The shopping cart communication system of claim 1, wherein the head up display is removably coupled to a handle or basket of the shopping cart.

11. The shopping cart communication system of claim 1, further comprising a server that communicates with the retail application on the mobile electronic device to provide data to the mobile electronic device, wherein the display data is generated in response to the data received by the mobile electronic device from the server.

12. The shopping cart communication system of claim 1, further comprising a charging system that produces power from motion of the shopping cart wheels, and provides the power to the head up display.

13. A shopping cart, comprising:
a frame;
a handle;
a set of wheels coupled to the frame;
a basket; and
a head up display removably or permanently coupled to the handle, basket, or frame, the head up display operable only by a mobile electronic device, wherein the head up display displays data received by the mobile electronic device.

14. The shopping cart of claim 13, wherein the head up display includes an extension to the mobile electronic device for operating only in response to the display data received from the mobile electronic device.

15. The shopping cart of claim 13, wherein the head up display is in a field of vision of a shopper behind the shopping cart handle, wherein a first region of the head up display provides a transparent or semi-transparent line of sight for the shopper, and wherein a second region of the head up display provides a display of the display data.

16. A method, comprising:
coupling a head up display to a shopping cart;
executing an application at a mobile electronic device;
providing a result of the executed application to the head up display; and
activating the head up display in response to the received result, and projecting an image from the data at a first region of the display.

17. The method of claim 16, wherein a user has a line of sight through a second region of the head up display.
